(19) United States
(12) Patent Application Publication
(10) Pub. No.: US 2003/0088480 A1
(43) Pub. Date: May 8, 2003

(54) Enabling recommendation systems to include general properties in the recommendation process

(75) Inventors: Frank Berghofer, Nidderau (DE); Hermann Stamm-Wilbrandt, Eberbach (DE); Lars Gendner, Berlin (DE); Michael Tsakonas, Berlin (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/282,881

(22) Filed: Oct. 29, 2002

(30) Foreign Application Priority Data
Oct. 31, 2001 (EP) 01125974.4

(51) Int. Cl. G06F 17/60

(52) U.S. Cl. 705/26

(57) ABSTRACT

A system for recommending items to a given user based on item recommendations of the given user and other users of the system, using general properties of users or items characterized by arbitrary property values as parameters of the recommendation process to improve recommendation quality.

### FIELD OF THE INVENTION

The present invention relates to recommendation systems capable of recommending items to a given user based on item recommendations of the same and other users of the system. More particularly the current invention relates to an improved technology for recommendation systems enabling general properties of users or items to participate in the recommendation process.

### BACKGROUND

A new area of technology with increasing importance is the domain “collaborative filtering” or “social filtering” of information. These technologies represent novel approaches to information filtering that do not rely on the “contents” of objects as is the case for content-based filtering. Instead, filtering relies on meta-data “about” objects. This meta data may be either collected automatically, that is data is inferred from users' interactions with the system (for instance by the time spent reading articles as an indicator of interest), or may be voluntarily provided by the users of the system. In essence, the main idea is to automate the process of “word-of-mouth” by which people recommend products or services to one another.

If one needs to choose between a variety of options with which one does not have any experience, one will often rely on the opinions of others who do have such experience. However, when there are thousands or millions of options, like in the Web, it becomes practically impossible for an individual to locate reliable experts that can give advice about each of the options. By shifting from an individual to a collective method of recommendation, the problem becomes more manageable.

Instead of asking for the opinion of each individual, one might try to determine an “average opinion” for the group. This, however, ignores a given person's particular interests, which may be different from those of the “average person”. Therefore one would rather like to hear the opinions of those people who have interests similar to one's own, that is to say, one would prefer a “division-of-labor” type of organization, where people only contribute to the domain they are specialized in.

The basic mechanism behind collaborative filtering systems is the following:

a large group of peoples' preferences are registered;

using a similarity metric, a subgroup is selected whose preferences are similar to the preferences of the person who seeks advice;

a (possibly weighted) average of the preferences for that subgroup is calculated;

the resulting preference function is used to recommend options on which the advice-seeker has expressed no personal opinion yet.

Typical similarity metrics are Pearson correlation coefficients between the users' preference functions and (less frequently) vector distances or dot products. If the similarity metric has indeed selected people with similar tastes, the chances are great that the options that are highly evaluated by that group will also be appreciated by the advice-seeker.

A typical application is the recommendation of books, music CDs, or movies. More generally, the method can be used for the selection of documents, services, products of any kind, or in general any type of resource.

In the world outside the Internet, rating and recommendations are provided by services such as:

Newspapers, magazines, books, which provide ratings by their editors or publishers, who select information which they think their readers want.

Consumer organizations and trade magazines which evaluate and rate products.

Published reviews of books, music, theater, films, etc.

Peer review method of selecting submissions to scientific journals.

Examples for these technologies are for instance the teachings of John B. Hey, “System and method of predicting subjective reactions”, U.S. Pat. No. 4,870,579 or John B. Hey, “System and method for recommending items”, U.S. Pat. No. 4,996,642, both assigned to Neonics Inc., as well as Christopher P. Bergh, Max E. Metral, David Henry Ritter, Jonathan Ari Sheena, James J. Sullivan, “Distributed system for facilitating exchange of user information and opinion using automated collaborative filtering”, U.S. Pat. No. 6,112,186, assigned to Microsoft Corporation.

In spite all these advances and especially due to the increased importance of the Internet, which provides the access technology and communication infrastructure to recommendation systems, there is still a need in the art for improvement.

Current state of the art recommendation systems are able to consider within the recommendation process only ratings of items.

Non-ratings, that is general properties of users or items characterized by arbitrary property values, cannot participate within the recommendation process. Simple examples of such general properties are for instance the age of a user, his location or address, or properties of items characterizing these items in more detail.

### SUMMARY

The present invention relates to recommendation systems capable of recommending items to a given user based on item recommendations of the given user and other users of the system.

Current state of the art recommendation systems are able to consider within the recommendation process only ratings of items. The current invention enables “non-ratings”, i.e., general properties of users or items characterized by arbitrary property values, to participate within the recommendation process to improve recommendation quality.

Recommendation systems according to the current invention comprise a recommendation scheme wherein for each of a multitude of users U and for each of multitude of items I, a profile P(U,I) comprises at least a rating.

According to the current invention, a recommendation system is improved by including one property item within the recommendation scheme, and by implementing a property value Y as the property rating of the property item, where the property rating depends on the distance between the property value Y and a selected property value X.

Thus, the current invention includes the use of a completely new information type in the recommendation process. Property values describing a certain property of a user or of an item in more detail can be used for similarity calculations. This results in a much more precise “picture” of each individual user, even when users are reluctant to provide explicit ratings for items. The suggested technology results in a more extensive characterization of an individual user, which offers a significant advantage in determining similar users reflected within the recommendation system. In other words, the similarity determination significantly benefits from the implicit rating information. Being able to determine users which are more similar to a given user significantly extends the scope of potential recommendations that can be determined. Further these techniques allow considerable improvement of the quality of the individual recommendations.

### BRIEF DESCRIPTION OF THE DRAWINGS

FIG. 1 gives an overview of the concepts of recommendation systems.

FIG. 2 depicts a preferred layout of the data structure common to user profiles and item profiles according to the current invention.

FIG. 3 shows an example of the combination of user profiles and item profiles reflecting a two-dimensional linkage.

FIG. 4 shows a first embodiment of the current invention wherein property items are based on a function; the function values are rating values that reflect an arbitrary property value X with respect to its similarity to the actually specified property value characterizing a certain user and/or item.

FIG. 5 shows a second embodiment of the current invention wherein each property item represents a certain selected property value of the property in question and the rating value associated with each property item reflects the similarity of its corresponding selected property value compared to the actually specified property value characterizing a given user and/or item.

### DETAILED DESCRIPTION

The drawings and specification set forth a preferred embodiment of the invention. Although specific terms are used, the description thus given uses terminology in a generic and descriptive sense only, and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when being loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

As referred to in this description, items to be recommended can be objects of any type. As mentioned above, an item may refer to any type of resource one can think of.

The following description refers to the notion of a property. This is to be understood as any feature, characteristic, attribute and the like characterizing a user or item with a property value.

Concepts of Recommendation Systems

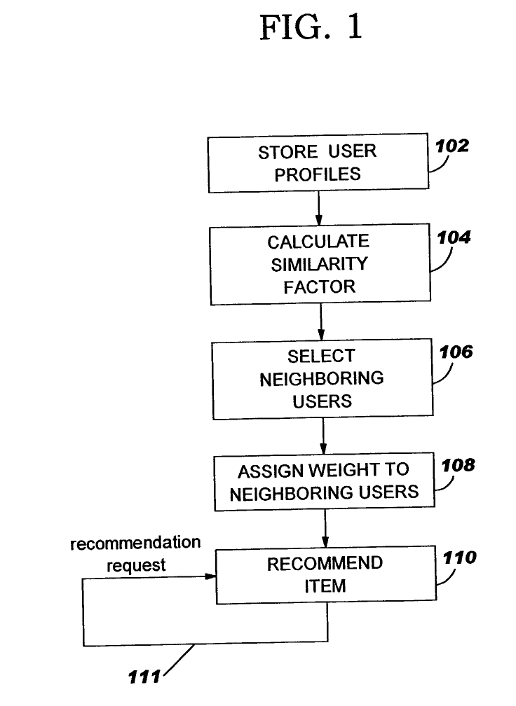

The following is a short outline on the basic concepts of recommendation systems. Referring now to FIG. 1, a method for recommending items begins by storing user and item information in profiles.

A plurality of user profiles is stored in a memory (step 102). One profile may be created for each user or multiple profiles may be created for a user to represent that user over multiple domains. Alternatively, a user may be represented in one domain by multiple profiles where each profile represents the proclivities of a user in a given set of circumstances. For example, a user that avoids seafood restaurants on Fridays, but not on other days of the week, could have one profile representing the user's restaurant preferences from Saturday through Thursday, and a second profile representing the user's restaurant preferences on Fridays. In some embodiments, a user profile represents more than one user. For example, a profile may be created which represents a woman and her husband for the purpose of selecting movies. Using this profile allows a movie recommendation to be given which takes into account the movie tastes of both individuals.

For convenience, the remainder of this specification will use the term “user” to refer to single users of the system, as well as “composite users.” The memory can be any memory known in the art that is capable of storing user profile data and allowing the user profiles to be updated, such as disc drive or random access memory. Each user profile associates items with the ratings given to those items by the user. Each user profile may also store information in addition to the user's rating. In one embodiment, the user profile stores information about the user, e.g. name, address, or age. In another embodiment, the user profile stores information about the rating, such as the time and date the user entered the rating for the item. User profiles can be any data construct that facilitates these associations, such as an array, although it is preferred to provide user profiles as sparse vectors of n-tuples. Each n-tuple contains at least an identifier representing the rated item and an identifier representing the rating that the user gave to the item, and may include any number of additional pieces of information regarding the item, the rating, or both. Some of the additional pieces of information stored in a user profile may be calculated based on other information in the profile. For example, an average rating for a particular selection of items (e.g., heavy metal albums) may be calculated and stored in the user's profile. In some embodiments, the profiles are provided as ordered n-tuples.

Whenever a user profile is created, a number of initial ratings for items may be solicited from the user. This can be done by providing the user with a particular set of items to rate corresponding to a particular group of items. Groups are genres of items and are discussed below in more detail. Other methods of soliciting ratings from the user may include: manual entry of item-rating pairs, in which the user simply submits a list of items and ratings assigned to those items; soliciting ratings by date of entry into the system, i.e., asking the user to rate the newest items added to the system; soliciting ratings for the items having the most ratings; or by allowing a user to rate items similar to an initial item selected by the user.

In still other embodiments, the system may acquire a number of ratings by monitoring the user's environment. For example, the system may assume that Web sites for which the user has created “bookmarks” are liked by that user and may use those sites as initial entries in the user's profile. One embodiment uses all of the methods described above and allows the user to select the particular method they wish to employ.

Ratings for items which are received from users can be of any form that allows users to record subjective impressions of items based on their experience of the item. For example, items may be rated on an alphabetic scale (“A” to “F”) or a numerical scale (1 to 10). In one embodiment, ratings are integers between 1 (lowest) and 7 (highest).

Any technology may be exploited to input these ratings into a computer system. Ratings may be inferred by the system from the user's usage pattern. For example, the system may monitor how long the user views a particular Web page and store in that user's profile an indication that the user likes the page, assuming that the longer the user views the page, the more the user likes the page. Alternatively, a system may monitor the user's actions to determine a rating of a particular item for the user. For example, the system may infer that a user likes an item which the user mails to many people, and enter in the user's profile an indication that the user likes that item. More than one aspect of user behavior may be monitored in order to infer ratings for that user, and in some embodiments, the system may have a higher confidence factor for a rating which it inferred by monitoring multiple aspects of user behavior. Confidence factors are discussed in more detail below.

Profiles for each item that has been rated by at least one user may also be stored in memory. Each item profile records how particular users have rated this particular item. Any data construct that associates ratings given to the item with the user assigning the rating can be used. It is preferable to provide item profiles as a sparse vector of n-tuples. Each n-tuple contains at least an identifier representing a particular user and an identifier representing the rating that user gave to the item, and may contain other information as well, as described above in connection with user profiles.

The additional information associated with each item-rating pair can be used by the system for a variety of purposes, such as assessing the validity of the rating data. For example, if the system records the time and date the rating was entered, or inferred from the user's environment, it can determine the age of a rating for an item. A rating which is very old may indicate that the rating is less valid than a rating entered recently. For example, users' tastes may change or “drift” over time. One of the fields of the n-tuple may represent whether the rating was entered by the user or inferred by the system. Ratings that are inferred by the system may be assumed to be less valid than ratings that are actually entered by the user. Other items of information may be stored, and any combination or subset of additional information may be used to assess rating validity. In some embodiments, this validity metric may be represented as a confidence factor, that is, the combined effect of the selected pieces of information recorded in the n-tuple may be quantified as a number. In some embodiments, that number may be expressed as a percentage representing the probability that the associated rating is incorrect or as an expected deviation of the predicted rating from the “correct” value.

The user profiles are accessed in order to calculate a similarity factor for each given user with respect to all other users (step 104). A similarity factor represents the degree of correlation between any two users with respect to the set of items. The calculation to be performed may be selected such that the more two users correlate, the closer the similarity factor is to zero.

Whenever a rating is received from a user or is inferred by the system from that user's behavior, the profile of that user may be updated as well as the profile of the item rated. Profile updates may be stored in a temporary memory location and entered at a convenient time, or profiles may be updated whenever a new rating is entered by or inferred for that user. Profiles can be updated by appending a new n-tuple of values to the set of already existing n-tuples in the profile or, if the new rating is a change to an existing rating, overwriting the appropriate entry in the user profile. Updating a profile also requires re-computation of any profile entries that are based on other information in the profile. Especially whenever a user's profile is updated with new rating-item n-tuple, new similarity factors between the user and other users of this system should be calculated. In other embodiments, similarity factors are periodically recalculated, or recalculated in response to some other stimulus, such as a change in a neighboring user's profile. The similarity factors for a user are calculated by comparing that user's profile with the profile of every other user of the system. This is computationally intensive, since the order of computation for calculating similarity factors in this manner is n², where n is the number of users of the system.

It is possible to reduce the computational load associated with recalculating similarity factors in embodiments that store item profiles by first retrieving the profiles of the newly-rated item and determining which other users have already rated that item. The similarity factors between the newly-rating user and the users that have already rated the item are the only similarity factors updated. In general, a method for calculating similarity factors between users should minimize the deviation between a predicted rating for an item and the rating a user would actually have given the item.

A similarity factor between users refers to any quantity which expresses the degree of correlation between two user's profiles for a particular set of items. The following methods for calculating the similarity factor are intended to be exemplary, and in no way exhaustive. Depending on the item domain, different methods will produce optimal results, since users in different domains may have different expectations for rating accuracy or speed of recommendations. Different methods may be used in a single domain, and, in some embodiments, the system allows users to select the method by which they want their similarity factors produced. In the following description of methods, D_{xy} represents the similarity factor calculated between two users, x and y. Hᵢₓ represents the rating given to item i by user x, I represents all items in the database, and Cᵢₓ is a Boolean quantity which is 1 if user x has rated item i and 0 if user x has not rated that item.

One method of calculating the similarity between a pair of users is to calculate the average squared difference between their ratings for mutually rated items. Thus, the similarity factor between user x and user y is calculated by subtracting, for each item rated by both users, the rating given to an item by user y from the rating given to that same item by user x and squaring the difference. The squared differences are summed and divided by the total number of items rated. This method is represented mathematically by the following expression:

$${D}_{xy} = \frac{{\sum }_{i ∈ I} {{c}_{ix} ( {c}_{iy} ( {H}_{ix} - {H}_{iy} ) )}^{2}}{{\sum }_{i ∈ I} {c}_{ix} {c}_{iy}}$$

A similar method of calculating the similarity factor between a pair of users is to divide the sum of their squared rating differences by the number of items rated by both users raised to a power. This method is represented by the following mathematical expression:

$${D}_{xy} = \frac{{\sum }_{i ∈ {C}_{xy}} {( {H}_{ix} - {H}_{iy} )}^{2}}{{\vert {C}_{xy} \vert}^{k}}$$

where |C_{xy}| represents the number of items rated by both users.

A third method for calculating the similarity factor between users factors into the calculation the degree of profile overlap, i.e. the number of items rated by both users compared with the total number of items rated by either one user or the other. Thus, for each item rated by both users, the rating given to an item by user y is subtracted from the rating given to that same item by user x. These differences are squared and then summed. The amount of profile overlap is taken into account by dividing the sum of squared rating differences by the number of items mutually rated by the users subtracted from the sum of the number of items rated by user x and the number of items rated by users y. This method is expressed mathematically by:

$${D}_{xy} = \frac{{\sum }_{i ∈ Cxy} {( {H}_{ix} - {H}_{iy} )}^{2}}{{\sum }_{i ∈ I} {c}_{ix} + {\sum }_{i ∈ I} {c}_{iy} - \vert {C}_{xy} \vert}$$

where |C_{xy}| represents the number of items mutually rated by users x and y.

In another embodiment, the similarity factor between two users is a Pearson r correlation coefficient. Alternatively, the similarity factor may be calculated by constraining the correlation coefficient with a predetermined average rating value, A. Using the constrained method, the correlation coefficient, which represents D_{xy}, is arrived at in the following manner. For each item rated by both users, A is subtracted from the rating given to the item by user x and the rating given to that same item by user y. Those differences are then multiplied. The summed product of rating differences is divided by the product of two sums. The first sum is the sum of the squared differences of the predefined average rating value, A, and the rating given to each item by user x. The second sum is the sum of the squared differences of the predefined average value, A, and the rating given to each item by user y. This method is expressed mathematically by:

$${D}_{xy} = \frac{{\sum }_{i ∈ Cxy} ( {H}_{ix} - A ) ( {H}_{iy} - A )}{{\sum }_{i ∈ {U}_{x}} {( {H}_{ix} - A )}^{2} + {\sum }_{i ∈ {U}_{y}} {( {H}_{iy} - A )}^{2}}$$

where Uₓ represents all items rated by x, U_{y} represents all items rated by y, and C_{xy} represents all items rated by both x and y. The additional information included in a n-tuple may also be used when calculating the similarity factor between two users. For example, the information may be considered separately in order to distinguish between users, e.g. if a user tends to rate items only at night and another user tends to rate items only during the day, the users may be considered dissimilar to some degree, regardless of the fact that they may have rated an identical set of items identically.

Regardless of the method used to generate them, or whether the additional information contained in the profiles is used, the similarity factors are used to select a plurality of users that have a high degree of correlation to a user (step 106). These users are called the user's “neighboring users.” A user may be selected as a neighboring user if that user's similarity factor with respect to the requesting user is better than a predetermined threshold value, L. The threshold value, L, can be set to any value which improves the predictive capability of the method. In general, the value of L may change depending on the method used to calculate the similarity factors, the item domain, and the size of the number of ratings that have been entered. In another embodiment, a predetermined number of users are selected from the users having a similarity factor better than L, e.g. the top twenty-five users. For embodiments in which confidence factors are calculated for each user-user similarity factor, the neighboring users can be selected based on having both a threshold value less than L and a confidence factor higher than a second predetermined threshold.

A user's neighboring user set should be updated each time that a new rating is entered by, or inferred for, that user. This requires determination of the identity of the neighboring users as well as all the similarity factors between the given user and its neighboring users. Moreover, due to the update of a certain rating of a first user the set of neighboring users of a multitude of other users should be changed. For instance this first user may need to be introduced or removed as a member of the set of neighboring users of other users in which case the involved similarity factors should be re-computed.

With increasing numbers of users and increased exploitations of recommendation systems, this need for continuous recomputation of precomputed neighboring users and their similarity factors becomes a real processing burden for such systems. Thus in many applications it is desirable to reduce the amount of computation required to maintain the appropriate set of neighboring users by limiting the number of user profiles consulted to create the set of neighboring users. In one embodiment, instead of updating the similarity factors between a rating user and every other user of the system (which has computational order of n²), only the similarity factors between the rating user and the rating user's neighbors, as well as the similarity factors between the rating user and the neighbors of the rating user's neighbors are updated. This limits the number of user profiles which must be compared to m² minus any degree of user overlap between the neighbor sets where m is a number smaller than n.

Once a set of neighboring users is chosen, a weight is assigned to each of the neighboring users (step 108). In one embodiment, the weights are assigned by subtracting the similarity factor calculated for each neighboring user from the threshold value and dividing by the threshold value. This provides a user weight that is higher, i.e. closer to one, when the similarity factor between two users is smaller. Thus, similar users are weighted more heavily than other, less similar, users. In other embodiments, the confidence factor can be used as the weight for the neighboring users. Of course many other approaches may be chosen to assign weights to neighboring users based on the calculated similarity factors.

Once weights are assigned to the neighboring users, an item is recommended to a user (step 110). For applications in which positive item recommendations are desired, items are recommended if the user's neighboring users have also rated the item highly. For an application desiring to warn users away from items, items are displayed as recommended against when the user's neighboring users have also given poor ratings to the item.

As indicated above, recommendation systems servicing a large number of users with a high-frequency of updating their rating values create a significant computation burden for the allocation of the precomputed similarity factors and neighboring users. Within the state of the art it is thus suggested that the similarity factors are recalculated periodically only, or are recalculated only in response to some other stimulus. This approach is reflected within FIG. 1, which shows that the steps 102 up to 110 to calculate the precomputed neighboring users (comprising similarity factors, weights and the neighboring users themselves) are performed only once (or at least with a low frequency) and provide a static basis for processing of a huge multitude of individual recommendation requests within step 111.

Efficiency is important in generating matchings and/or recommendations. Efficiency will be experienced by a user in terms of the system's latency, i.e. the time required to process a user's recommendation request. From the perspective of recommendation systems themselves the efficiency aspect is related to the frequency in which recommendation requests are entered into recommendation systems for processing. For online businesses, latency in the sub-second area is a must.

In European patent application number 01111407.1 with IBM as applicant, another type of recommendation system is disclosed which avoids the requirement of creation and maintenance of static, precomputed similarity factors stored persistently. This teaching suggests computing on a temporary basis only, for each individual recommendation request of a given user, the similarity factors measuring the similarity between the given user and the multitude of users. Such techniques may be applied to the current invention as well, as the current invention is independent from the specific technique of how and when similarity factors are calculated.

One example of a potentially more detailed structure of the various profiles (user profiles, item profiles) is discussed next. In this exemplary embodiment, the combination of user profiles and item profiles includes a multitude of identical data structures each comprising at least a user identification, an item identification, and a corresponding rating value (potentially enhanced with computed similarity factors). For efficient use of the computer's memory, this common data structure should be limited in size.

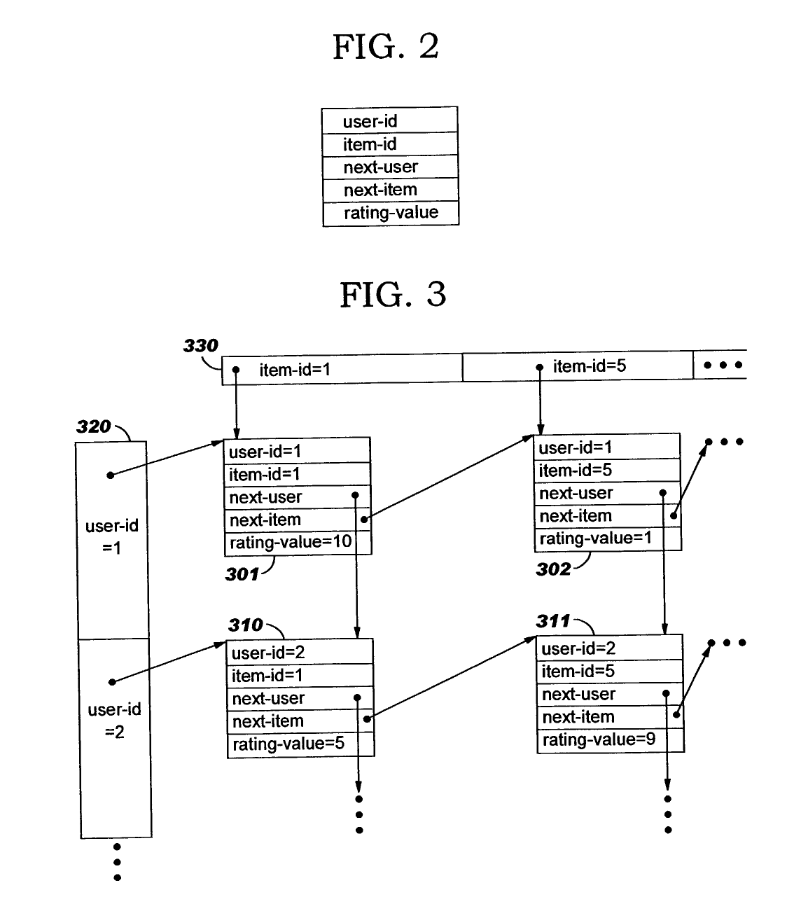

A potential layout of this data structure common to user profiles and item profiles is depicted in FIG. 2. Each rating or normull matrix entry is represented by a tuple comprising as least the following data elements:

user-id: identification of a certain user

item-id: identification of a certain item

Next-user: a link to an identical data structure characterizing the next user in a sequence according the user-ids

Next-item: a link to an identical data structure characterizing the next item in a sequence according the item-ids

rating value: the rating value of the item characterized by an item-id provided by a user characterized by a user-id.

Of course this list may be enhanced by similarity factors computed by comparing the ratings of the various users.

To allow these data structures to be easily searched by the computer system, they are linked in two dimensions, resulting in a matrix-like structure. FIG. 3 shows an example of the combination of user profiles and item profiles reflecting the two dimensional linkage. The first dimension 320 links all data structures with the same user identification in a sequence according to the item identifications (user profile). The second dimension 330 links all data structures with the same item identification in a sequence according to the user identifications (item profile). Referring to FIG. 3 examples of the basic data structure are depicted by 301, 302, 310, 311. In the horizontal dimension these elementary data structures are linked thus, so that each row represents the user profile. In the vertical dimension these elementary data structures are all linked thus, so that each column represents one item profile.

Fundamental Observations and Basic Approach

The following observations provide a deeper insight into the problems with the state of the art. These observations further reveal the cause of these problems and in a step by step process explain the solution proposed by the current invention.

A serious deficiency of the state of the art concerns poor recommendation quality due to getting inadequate information from users. It therefore acknowledges the reluctance of most humans to give too much information, either because of workload or privacy concerns. In other cases, users are not aware of the nature of the information required by a recommendation system to improve the recommendation quality. On the other hand, some users provide a lot of information, which is not of the nature of a rating value and thus cannot be exploited within the recommendation process. For instance, a user may be willing to provide a lot of registration information for setting up their profile when enrolling with a recommendation system. Such registration information can be the user's name, address information, profession, range of monthly salary, and the like. The nature of this information is that of a property being characterized by a property value. Such property situations also occur with items. For instance, think of a certain user stating that he/she prefers to spend vacations within a certain graphic location. As another example, one could think of systems allowing a first person to find a second person to establish a personal relationship or even marriage. Such situations are out of the realm of recommendation systems, as this would require modeling desired properties of potential partners as “items” having certain property values (such as height, hair color, salary, or education).

A fundamental observation underlying the current invention is that it is possible to allow such properties to participate within a recommendation process if these properties are modeled as items called property items, within the recommendation scheme. If a certain user specifies a certain property value Y for such a property item, a rating value may be calculated for this fact along the following lines:

a. assume a selected property value x of the properties under consideration defined beforehand;

b. then a rating value can be associated with the property value Y by judging the similarity of the specified property value Y with its corresponding selected property value X. With this approach all arbitrary property values Y become comparable by judging these values from a selected perspective, namely the selected property value X.

The proposed rating value actually is measuring the “distance” between a user specified property value Y with respect to the selected property value X. The concept of a distance depends on the particular property to be rated, and can be any measure allowing comparison of two property values of that property. For instance, if the property is the home address and the individual property values are the name of the town and street, the above mentioned distance between X and Y could be the travel distance in miles between X and Y.

Two more concrete embodiments are included below for the aforementioned concept.

Embodiment 1:

In a first embodiment the selected property value X could be thought of as being a variable. In this case the rating value for a concrete property value Y is not a mere number but much more a function F. This function F, the rating function, judges the “distance” between the concrete property value Y and the selected property value X. In more mathematical terms this could be written as

rating value:=F (Distance (X,Y)

Upon receiving a concrete property value Y from a user, the recommendation system would generate the above defined function as an evaluatable expression, which would be stored as a rating value within the profile being part of the recommendation scheme. At runtime, to calculate similarities between different users this function would be evaluated to determine the differences of the rating values of two different users. Let Y1 and Y2 represent the explicit property values specified by user 1 and user 2. The following approaches represent examples how the function F may be used by the recommendation system for determining the differences with respect to the rating values: for a set of selected property values X

difference of rating values =∫[F(X,Y1)−F(X,Y2)]dX

for a set of selected property values Xi

$$difference of rating values = {\sum }_{i} [ F ( {X}_{i} , Y1 ) - f ( {X}_{i} , Y2 ) ]$$

Embodiment 2:

A second embodiment includes selected property values Xi, i=1, . . . , n with predefined numerical values. In this case, for each Xi a separate property item is introduced. Each of these property items may be viewed as measuring the user specified property value from a certain perspective Xi. If at runtime a given user specifies property value Y, the recommendation system calculate for each Xi the corresponding rating value

rating value:=F (Distance (Xi,Y)

and stores it within the corresponding profile of the recommendation scheme. With this embodiment similarity calculation can be performed as known within the state of the art.

Item Properties Rated by Rating Functions According to Embodiment 1

In recommendation systems the similarity between a given user and other users is computed either each time a recommendation for a user is requested, or recalculated at regular points in time (for instance if a certain number of new ratings have been stored within the recommendation scheme).

This kind of recommendation system may be enhanced by generalizing the individual rating values Hᵢₓ beyond numbers. As described above for property items, one could think of functions as rating values instead of mere numbers, wherein the function depends on a variable which can take any potential value within the domain of potential property values. Then it needs to be specified how the difference of rating functions, now a difference of functions, is to be evaluated for property item i and users x and y.

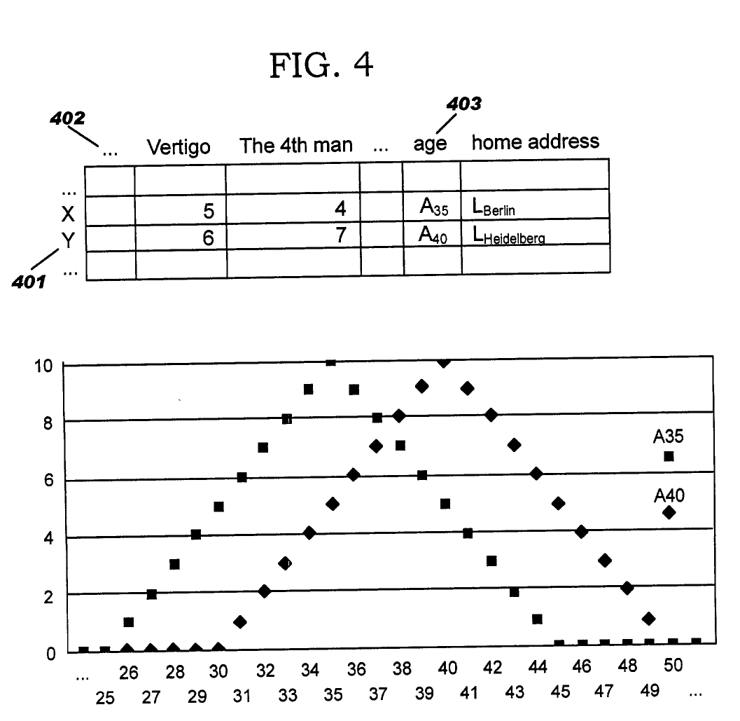

The new possibilities can be illustrated by an example for the property item <age>on domain V={0,1,2, . . . , 199}. One could define the fuzzy-like function A_{b}(a):=min{0,10−|a−b|} as a rating value, to be more precise as a rating function in the sense of the above description, of property item <age> for any user of age b. In this case “b” would represent the concrete age (or in general terms, the concrete property value) as specified by a certain user. Then, “a” would represent the variable which could take any value from within the domain of the property values of property <age>. This aspect is visualized within FIG. 4. The upper part of FIG. 4 shows the recommendation scheme as a matrix-like structure of profiles. The vertical dimension 401 indicates the various users within the recommendation scheme while the horizontal dimension indicates the various items participating within the recommendation scheme. Property item <age> 403 is realized by the suggested rating functions instead of mere rating values. The lower part of FIG. 4 shows two rating functions, one for a user specified age of b=35 and the other for an age of b=40. This rating function provides large values near age value b, the maximum 10 for age value b, and 0 for totally dissimilar age values. In this case the rating values Hᵢₓ actually are rating functions and the difference of the two functions could be expressed as a further summation (in accordance with above description under). Thus the summation of the squared differences over the property value domain V is a good choice:

$$( {H}_{ix} - {H}_{iy} ) := {\sum }_{v ∈ V} {( {H}_{ix} ( v ) - {H}_{iy} ( v ) )}^{2}$$

Another example for a property item could be the <home address> of the users. Even users of the internet, especially users of community platforms, like to meet in the real world. Therefore the incorporation of the home address information is an important community aspect in recommendation systems. The property item <home address> domain is for instance W={Berlin,Hamburg,Heidelberg,London, . . . }, i.e., all cities in the world, or perhaps a subset of “regional centers”. For the rating function one could define in this case:

dist(a, b):=geographic_{—}dist between a and b in km

and the fuzzy-like function

L_{b}(a):=min{0,100−dist(a,b)}

as a rating function of property item <home address> for any user with a user specified home address b, i.e. a is the variable of the rating function. This function provides large values near b, the maximum 100 for home address value b, and 0 for totally dissimilar home address values. In this case again the rating values Hᵢₓ actually are rating functions and the difference of the two functions could be expressed as a further summation (in accordance with the above description). Thus the summation of the squared differences over the property value domain W is a good choice:

$$( {H}_{ix} - {H}_{iy} ) := {\sum }_{v ∈ W} {( {H}_{ix} ( v ) - {H}_{iy} ( v ) )}^{2}$$

Based on these enhancements of recommendation systems including property items, the scenario of providing a recommendation, which is now being based on rating functions instead of mere rating values, works as follows (refer to the example of FIG. 4): X is of age 35, has home address Berlin and is interested in the movies “Vertigo” and “The 4th man”; and Y is of age 40, has home address Heidelberg and is interested in “Vertigo” and “The 4th man” slightly differently.

For the computation of D_{xy} the following values from the table of FIG. 4 are important:

c_{vertigo,X}=1, C_{The 4th man,X}=1, C_{age,X}=1, C_{home address,X}=1

H_{Vertigo,X}=5, H_{The 4th man,X}=4, H_{age,X}=A35, H_{home address,X}=L_{Berlin}

c_{Vertigo,Y}=1, C_{The 4th man,Y}=1, c_{age,Y}=1, C_{home address,Y}=1

H_{vertigo,Y}=6, H_{The 4th man,Y}=7 H_{age,Y}=A₄₀, H_{home address,Y}=L_{Heidelberg}

The rating functions A₃₅ and A₄₀ are depicted graphically in the chart of FIG. 4. Their difference is calculated for A₃₅ and A₄₀ by:

$$\begin{matrix}( {A}_{35} - {A}_{40} ) = \sqrt{\begin{matrix}0 + … + 0 + {1}^{2} + {2}^{2} + {3}^{2} + {4}^{2} + 6 * \\ {5}^{2} + {3}^{2} + {1}^{2} + {1}^{2} + {3}^{2} + 6 * \\ {5}^{2} + {4}^{2} + {3}^{2} + {2}^{2} + {1}^{2}\end{matrix}} \\ = \sqrt{380}\end{matrix}$$

(L_{Berlin}−L_{Heidelberg})=0 because of dist(Berlin,Heidelberg)>100. Now the similarity computation is given by:

$$\begin{matrix}{D}_{XY} = \frac{( 1 * 1 * {( 5 - 6 )}^{2} + 1 * 1 * {( 4 - 7 )}^{2} + 1 * 1 * ( {A}_{35} - {A}_{40} ) + 1}{1 * 1 + 1 * 1 + 1 * 1 + 1 * 1} \\ = \frac{1 + 9 + 380 + 0}{4} \\ = 92.5\end{matrix}$$

Below the same scenario is discussed based on another embodiment of the current invention, but the same similarity value.

Similarity computation between users (eg scalar product) depending on time (simplest examples: day/night or weekday/weekend) is possible in this scenario just by rating with time dependent functions as property item ratings; this represents a further enhancement with respect to the state of the art for recommendation systems.

Item Properties Rated by Rating Functions According to Embodiment 2

In case the technical obstacles are prohibitive for enhancing an existing recommendation system enabling it to handle rating functions in addition to mere rating value for computation of similarity factors, the following second embodiment is another realization of the current invention.

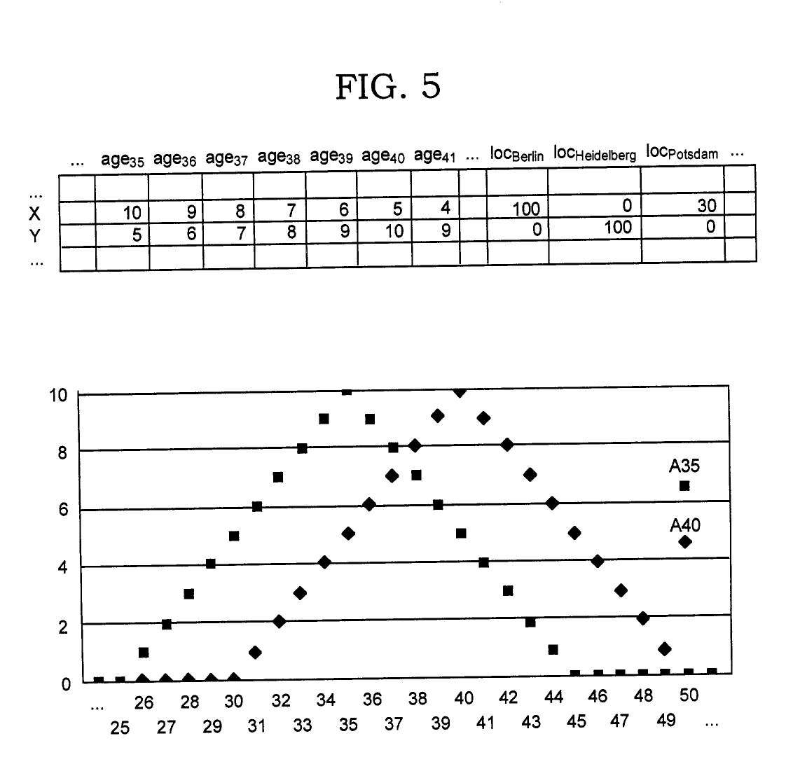

As with the previous example a property <age> with a domain of V={0,1,2, . . . ,199} is assumed. To avoid the introduction of a rating function, the particular property <age> is represented not by a single property item but by a set of property items. Thus the special property items I_{age}={age₀,age₁,age₂, . . . ,age₁₉₉} are created to cover all possible ages of humans. This enhancement of the recommendation scheme is visualized in the upper part of FIG. 5 which is otherwise identical to the example of FIG. 4. Each of these property items measures the user specified property value b from a certain perspective i; i.e. from the perspective of the base points I_{age}. Thus for any user U with a specified age b, one arrives at the following rating values of the new property items:

rating(U, ageᵢ)=A_{b}(i) for all iεV

When calculating the similarity values for instances according to the above mentioned expression D_{xy} for the difference of the ratings of the property item <age>, (Hᵢₓ−H_{iy}) actually is a sum of differences over the property value domain V. Thus,

$$( {H}_{ix} - {H}_{iy} ) := \sqrt{{\sum }_{v ∈ V} {( {H}_{ix} ( v ) - {H}_{iy} ( v ) )}^{2}}$$

is a good choice. With a slight change of the definition of

$${c}_{ix} = \frac{1}{\sqrt{\vert V \vert}}$$

for property items i on domain V this results in exactly the same similarity values as in the age scenario of the example for embodiment 1 above.

Also the above mentioned property example relating to a property of a <home address> of the users can be realized with this second embodiment. This example would result in the following special property items L={loc_{Berlin},loc_{Heidelberg},loc_{Hamburg},loc_{London}, . . . } to cover all possible home addresses. Then the rating values for the individual property items for the individual base points L for any user U of home address b is:

rating(U, locᵢ)=L_{b}(i) for all iεW

In this case the summation of the square root of the squared differences over the property value domain W,

$$( {H}_{ix} - {H}_{iy} ) := \sqrt{{\sum }_{v ∈ W} {( {H}_{ix} ( v ) - {H}_{iy} ( v ) )}^{2}}$$

is a good choice because, in addition to a slight change of the definition of

$${c}_{ix} = \frac{1}{\sqrt{\vert W \vert}}$$

for property items i on domain W, this results in exactly the same similarity values as in the <home address> scenario of the first embodiment of the invention described above.

Based on these enhancements of recommendation systems including a multitude of property items to handle a single property, the scenario of providing a recommendation, which is now being based on multitude of rating values, works as follows (refer to the example of FIG. 5).

For the computation of D_{xy} the following values from the table of FIG. 5 are important:

$$\begin{matrix}□ {c}_{Vertigo , X} = 1 , {c}_{The 4 th man , X} = 1 , {c}_{age0 , X} = \frac{1}{\sqrt{200}} , … , \\ {c}_{age199 , X} = \frac{1}{\sqrt{200}} , {c}_{locBerlin , X} = \frac{1}{\sqrt{\vert W \vert}} \\ □ {H}_{Vertigo , X} = 5 , {H}_{The 4 th man , X} = 4 , {H}_{age0 , X} = 0 , … , \\ {H}_{age199 , X} = 0 , {H}_{locBerlin , X} = 100 \\ □ {c}_{Vertigo , Y } = 1 , {c}_{The 4 th man , Y} = 1 , {c}_{age0 , Y} = \frac{1}{\sqrt{200}} , … , \\ {c}_{age199 , Y} = \frac{1}{\sqrt{200}} , {c}_{locHeidelberg , X} = \frac{1}{\sqrt{\vert W \vert}} \\ □ {H}_{Vertigo , Y} = 6 , {H}_{The 4 th man , Y} = 7 , {H}_{age0 , Y} = 0 , … , \\ {H}_{age199 , Y} = 0 , {H}_{locBerlin , Y} = 0\end{matrix}$$

The functions A₃₅ and A₄₀ are depicted graphically in the chart of FIG. 5. The similarity computation leads to the following result:

$$\begin{matrix}{D}_{XY} = \frac{\begin{matrix}( 1 * 1 * {( 5 - 6 )}^{2} + 1 * 1 * {( 4 - 7 )}^{2} + \\ 1 * 1 * {( 1 - 0 )}^{2} + 1 * 1 * {( 2 - 0 )}^{2} + … )\end{matrix}}{1 * 1 + 1 * 1 + 200 * \frac{1}{\sqrt{200}} \frac{1}{\sqrt{200}} + …} \\ = \frac{1 + 9 + 380 + 0}{4} \\ = 92.5\end{matrix}$$

Thus both embodiments of the same example result in identical similarity factors.

We claim:

1. A computer system for providing item recommendations that takes into account at least one property characterized by at least one property value, said system comprising:
a recommendation scheme having a profile that includes at least one rating for each user of a plurality of users and each item of a plurality of items, said recommendation scheme taking into account at least one property item having said property in making a recommendation, said scheme implementing a given property value as a property rating of said property item, said property rating depending on a distance between the given property value and a selected property value.

2. The system of claim 1, wherein the property rating is a function, and the selected property value is a variable.

3. The system of claim 2, wherein the function is a expression that is evaluated to determine similarity between two users.

4. The system of claim 1, wherein the property belongs to a plurality of property items each with a property rating, each property rating being dependent on a different property value.

5. The system of claim 1, wherein the property is a property of the plurality of users.

6. The system of claim 5, wherein the property is user age.

7. The system of claim 5, wherein the property is user location.

8. The system of claim 5, wherein the property is user address.

9. The system of claim 1, wherein the property is a property of an object.
